(19) United States
(12) Patent Application Publication
(10) Pub. No.: US 2018/0009648 A1
(43) Pub. Date: Jan. 11, 2018

(54) Reusable Vessel for Dispensing Beverages and Method of Storing and Dispensing Beverages

(71) Applicant: John Theodore Astolfi, Stuart, FL (US)

(72) Inventor: John Theodore Astolfi, Stuart, FL (US)

(21) Appl. No.: 15/662,958

(22) Filed: Jul. 28, 2017

Related U.S. Application Data
(63) Continuation of application No. 15/170,066, filed on Jun. 1, 2016, now abandoned.
Application No. 15/170,066 is a continuation of application No. 14/672,141, filed on Mar. 28, 2015, now abandoned.
Application No. 14/672,141 is a continuation of application No. 14/450,258, filed on Aug. 3, 2014, now abandoned.
Application No. 14/450,258 is a continuation of application No. 13/440,609, filed on Apr. 5, 2012, now abandoned.
Application No. 15/170,066 is a continuation of application No. 14/672,141, filed on Mar. 28, 2015, now abandoned.
Application No. 14/672,141 is a continuation of application No. 14/450,258, filed on Aug. 3, 2014, now abandoned.
Application No. 14/450,258 is a continuation of application No. 13/440,609, filed on Apr. 5, 2012, now abandoned.

(51) Int. Cl. B67D 1/04; B67D 1/00; B67D 1/08

(52) U.S. Cl. CPC B67D 1/0418; B67D 1/0804; B67D 1/008; B67D 1/0004; B67D 1/0412; B67D 2001/0481; B67D 2001/0822

(57) ABSTRACT

The invention includes a vessel comprised of a rectilinear primary casing made from a polymer material and a removable dispenser and methods of dispensing and filling and cleaning the vessel. The vessel further includes a one-way valve that may be used to introduce gases to the vessel once the dispenser is attached and sealed to the primary casing, an optional integrated handle and optional integrated feet.

### CROSS-REFERENCE TO RELATED APPLICATION

This application is a continuation of U.S. nonprovisional application Ser. No. 15/170,066 filed Jun. 1, 2016, which is a continuation of U.S. nonprovisional application Ser. No. 14/672,141 filed Mar. 28, 2015, which is a continuation of U.S. nonprovisional application Ser. No. 14/450,258 filed Aug. 3, 2014, which is a continuation of U.S. nonprovisional application Ser. No. 13/440,609, filed Apr. 5, 2012.

### FIELD OF THE INVENTION

Aspects of the invention relate generally to vessels for storing beverages, more particularly a vessel for storing carbonated beverages such as beer.

### BACKGROUND

Historically, home brewers, particularly those brewing beer, have been forced to either individually bottle or keg the entire batch. Beer and other fermented beverages are not traditionally stored in standard plastic containers like milk or water jugs, because pressure must be maintained in these beverages in order to keep them fresh. The kegging process requires a significant financial investment in equipment and a significant investment of space for the keg and its associated equipment, including purchasing not only the keg but a dedicated refrigerator or kegerator. Refrigeration capacities also often limit the number of varieties of beer or other beverages that a home brewer can have on tap.

A 5-gallon batch of beer yields approximately 55-12-oz bottles. Bottling is a tedious and time-consuming process that involves washing, brushing, rinsing, sanitizing, filling, and capping each bottle. These processes often involve unexpected frustrations, such as bent caps and broken cappers, and thus many home brewers dread bottling beer.

Very few options exist for the home brewer who wishes to store brewed beer, root beer, cider, or other carbonated or fermented beverages in quantities larger than a single bottle but smaller than an entire keg. There is a need for an improved beer storage and secondary fermentation vessel which may be easily kept in a standard home refrigerator, can be easily labeled, and allows for direct dispensing to a drinking vessel.

### SUMMARY OF THE INVENTION

The present invention includes a vessel comprised of a rectilinear primary casing made from a polymer material and a removable dispenser. The vessel further includes a one-way valve that may be used to introduce gases to the vessel once the dispenser is attached and sealed to the primary casing. The invention may further include integrated feet, which may serve as a reservoir for sediment from the liquid contained therein to settle. The invention may also include an integrated top handle.

The invention further includes a method of dispensing beverage from the vessel, a method of filling the vessel, and a method of cleaning the vessel.

### BRIEF DESCRIPTION OF THE DRAWINGS

The above and other objects, features, and advantages of the invention will become more apparent from the following description of certain preferred embodiments thereof, when taken in conjunction with the accompanying drawings in which:

FIG. 1 depicts a perspective view of an assembled beverage storage container according to one embodiment of the invention.

FIG. 2 depicts a side view of the primary casing of a beverage storage container according to one embodiment of the invention.

FIG. 3 depicts a perspective view of a primary casing of a beverage storage container according to an embodiment of the invention.

FIG. 4 depicts a top view of a primary casing of a beverage storage container according to an embodiment of the invention.

FIG. 5 depicts a front view of a primary casing of a beverage storage container according to an embodiment of the invention.

FIG. 6 depicts a side view of a dispenser cap base according to an embodiment of the invention.

FIG. 7 depicts a side view cross section of a dispenser cap base according to an embodiment of the invention.

FIG. 8 depicts a perspective view of a dispenser cap base according to an embodiment of the invention.

FIGS. 9A and 9B depict a perspective view and side view of the parts of an unassembled dispenser assembly that includes a hose adapter and lever arm stopper dispensing mechanism according to an embodiment of the invention.

FIGS. 10A, 10B, and 10C depict a side cross section side view, perspective view, and side view, respectively, of a an optional hose adapter for the dispenser cap according to an embodiment of the invention.

FIG. 11 depicts a side view cross section of an assembled dispenser assembly that includes a hose adapter and lever arm stopper dispensing mechanism according to an embodiment of the invention.

FIGS. 12A, 12B, and 12C depict a perspective view, cutaway side view, and side view, respectively, of an optional hose dispenser assembly according to an embodiment of the invention.

FIGS. 13A, 13B, and 13C, depict a perspective view, cutaway side view, side view, respectively, of a dispenser screw cap according to an embodiment of the invention.

FIGS. 14A, 14B, and 14C depict a perspective view, cutaway side view, and side view, respectively, of a threaded end cap, which is used to attach a valve/spring dispensing mechanism assembly according to an embodiment of the invention.

FIG. 15 depicts a side view of a silicone rubber valve stop, including dotted lines showing the placement of a valve pin, which is part of a valve/spring dispensing mechanism assembly, according to an embodiment of the invention.

FIG. 16 depicts a side view of a spring, which is a component of a valve/spring dispensing mechanism assembly according to an embodiment of the invention.

FIG. 17 depicts a side view of a valve pin, which is a component of a valve/spring dispensing mechanism assembly according to an embodiment of the invention.

FIGS. 18A, 18B, and 18C depict a top view, side view, and bottom view, respectively, of a valve lever, which is a component of a valve/spring dispensing mechanism assembly according to an embodiment of the invention.

FIG. 19 depicts a perspective view of a beverage storage container according to one embodiment of the invention as well as the disassembled valve assembly and pressurization source.

FIG. 20 depicts a side cross section view of an assembled beverage storage container with the valve assembly and pressurization source attached according to an embodiment of the invention.

### DETAILED DESCRIPTION OF PREFERRED EMBODIMENTS

The present invention now will be described more fully hereinafter with reference to the accompanying drawings, in which preferred embodiments of the invention are shown. The invention may, however, be embodied in many different forms and should not be construed as limited to the embodiments set forth herein; rather, these embodiments are provided so that this disclosure will be thorough and complete and convey the scope of the invention to those skilled in the art. Like numbers refer to like elements throughout.

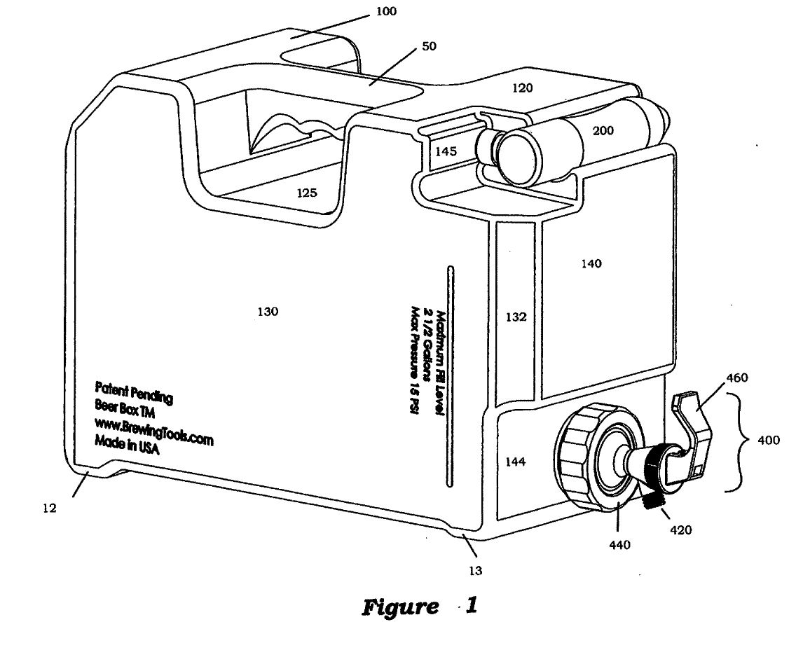

According to FIG. 1, an embodiment of the invention comprises a primary casing generally designated 100, in an approximately rectangular prismatic shape with several indentations, cut outs, and other features, as will be described further in this application. The primary casing is preferably comprised of a polymer, more preferably high-density polyethylene, most preferably an amber, brown or other light limiting shade of high-density polyethylene, which has been blow molded to form an approximately rectangular shape as will be described below. An embodiment of the invention also comprises a dispenser assembly, generally designated 400, which will be described in detail further below, and a pressurization source, generally designated 200, which will also be described in detail further in this application. In an alternate embodiment of the invention, the dispenser assembly 400 may be replaced by a lower travel cap. In yet another alternate embodiment of the invention, the pressurization source 200 may also be replaced by an upper travel cap.

As shown in FIGS. 1-5, the primary casing is comprised of a supporting bottom face 110, a top face 120, two side faces 130 and 170 (not shown), a front face 140, and a back face 150, oriented approximately as a rectangular prism. According to an embodiment of the invention as shown in FIGS. 1-3, the front side of the primary casing includes an indented or carved-out lower portion with a lower front face 144. On the lower front face, preferably approximately horizontally centered on the lower front face 144, is a dispenser hole 430. According to a preferred embodiment of the invention, there is a circular dispenser attachment protrusion 410 around the dispenser hole for attachment of various types of dispenser assemblies for the beverage within. Preferably, the circular dispenser attachment protrusion 410 has threads so that a dispenser spout, cap, or other piece or assembly may be screwed on. Though it is not necessary for the dispenser spout or other piece or assembly to remain flush with the surface of the front face, the carved out lower-portion according to this embodiment minimizes the protrusion of the spout or dispenser assembly from the overall front surface of the container assembly. The dispenser hole 430 may also be used for filling the container with the beverage to be stored.

According to an embodiment of the invention, the dispenser hole 430 may be used to clean out the vessel. Thus, according to these embodiments, the dispenser hole needs to have a large enough diameter for inserting water and small brushes and other apparatuses to clean out the vessel. It is further understood by those skilled in the art that the dispenser hole can vary in size based on the size needed to attach an adequate dispenser and for various cleaning tools. In some preferred embodiments, the dispensing hole diameter ranges from approximately 0.5 inches to 2 inches. In more preferred embodiments, the dispense hole is at least 1.5 inches in diameter to allow a brush of at least 1 inch in width to be inserted for cleaning. Larger and smaller dispenser holes may be used in different embodiments. In a preferred embodiment of the invention designed for approximately 2.5 gallons of liquid beverage, the dispenser hole diameter is about 1.5 inches in diameter.

According to an embodiment of the invention, the front face 140 is relatively flat and smooth to accommodate placement of a standard beer bottle label (typically a 4 inch by 4 inch square label) on the outside of the vessel. According to an embodiment of the invention, the front face 140 and/or any of the faces of the primary casing may include raised text or other indicators for identification of the beverage, the vessel manufacturer, or to convey other important information.

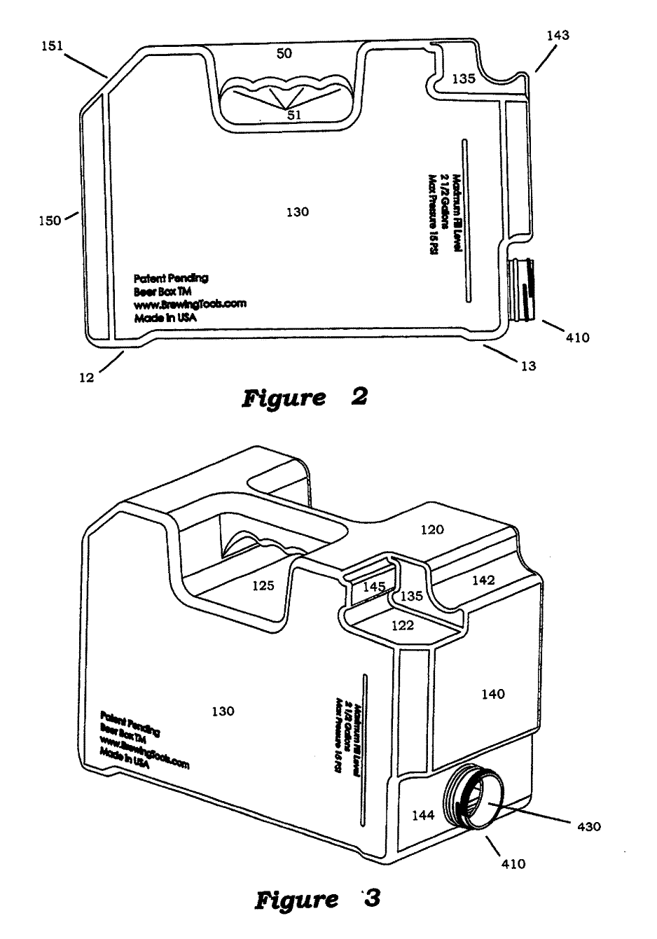

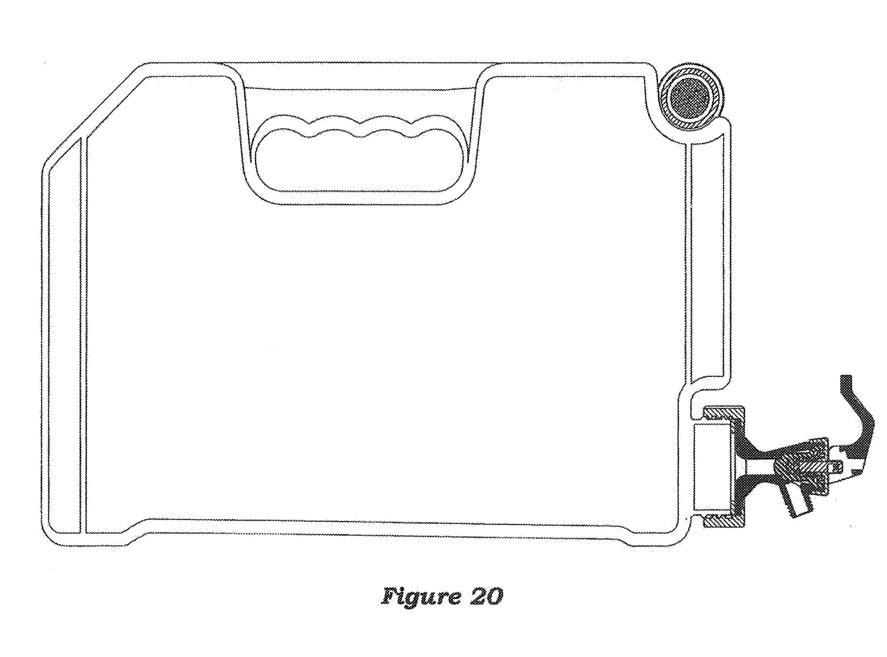

According to an embodiment of the invention as shown in FIGS. 1-5, the front side of the primary casing also includes upper indentations or upper carved-out regions. As shown in FIG. 3, this embodiment of the invention includes an indented region from the front, side, and upper region comprising a small upper left front panel 145, a small top panel 122, and a small side panel 135. As shown on FIG. 19, a small top hole and valve 146, may be located on this small upper left front panel. Whereas the dispenser hole 430, located near the bottom of the primary casing, may be used for filling or dispensing of the beverage, the top hole or valve 146 is used to attach a means for providing pressure to the beverage container. According to an embodiment of the invention as shown in FIG. 19, this includes a one-way valve that is pushed through the top hole 146 and attached with a washer, o-ring, and nut. As shown in FIG. 3, an embodiment of the invention also includes another upper indented region comprising an upper seating panel 142 for placement of a pressurizing cartridge or gas tube. The upper indented region comprising an upper seating panel 142 may be curved, as shown in FIGS. 2-3 such that the pressurizing cartridge can seat within the indentation and may even be sized such that a standard-sized cartridge may snap or slide into place. According to one embodiment of the invention, the curvature of the upper seating panel 142 includes an upper seating protrusion 143 to prevent a pressurization cartridge or pressurization hose from coming off when the container is tipped slightly forward. It is understood that though in the figures the small upper left panel 145 and the upper seating panel 142 are located on the left and right, respectively, of the front side of the primary casing, their positions may be reversed such that the small upper left panel may be on the right of the front and the upper seating panel may be located on the left.

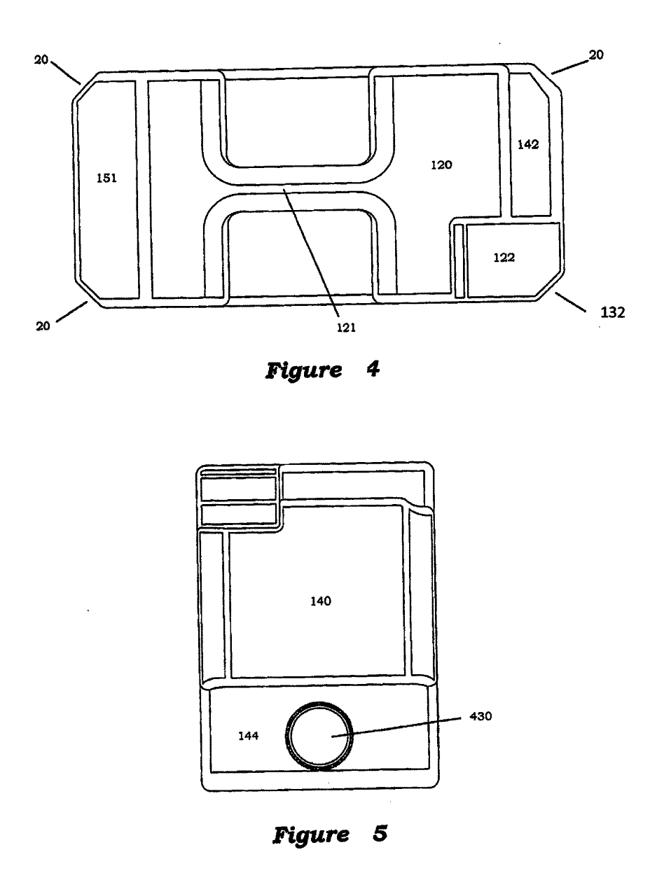

According to an embodiment of the invention as shown in FIGS. 1-4, the primary casing is also comprised of a top indented region and an integrated handle 50. As shown in FIG. 4, according to these embodiments of the invention, the top face 120, rather than being shaped like a rectangle, is shaped approximately like an “I”, with the center of the “I” 121 serving as the top of the integrated handle. As shown in FIG. 1-2, the integrated handle 50, according to these embodiments of the invention, is molded into the plastic casing, and is approximately cylindrical, with ergonomic indentations 51 located at the bottom of the cylinder for placement of the fingers of the person carrying the container. A lower top face 125 is located under the integrated handle 51.

According to an embodiment of the invention, the top face 120 and the back face 150, rather than coming together at an approximate right angle, may be joined by an upper back face 151. Similarly, other sides of the approximately rectangular prism, such as the front face and side face, may be connected by corner panels 20, 132 rather than coming together at an approximate right angle. Such corner panels 20, 132 and upper back face 151 serve to strengthen the vessel such that it can withstand higher pressures, yet the vessel maintains ease of manufacture using inexpensive techniques such as blow molding techniques.

The primary casing 100 is also comprised of a bottom face 110. The bottom face may, according to an embodiment, further comprise at least two integrated feet. According to the embodiment of the invention provided in FIG. 1-3, the bottom surface includes a back integrated foot 12, which extends along the length of the bottom surface from the left side 130 to the right side, and a front integrated foot 13, which also extends along the width of the bottom surface from the left side 130 to the right side. The integrated feet provide a space for sediment to settle without interfering with the flow of the beverage into the dispenser. According to an embodiment of the invention, the back integrated foot 12 has a higher height than the front integrated foot 13, such that when the container is placed on a flat surface, the container is essentially sloped toward the front, which helps to direct the flow of the liquid toward the dispenser hole 430.

According to an embodiment of the invention, the left side 130 or the right side or both may include a level indicator, which may be raised, translucent, graduated, or otherwise designed for ease of use, to assist the person handling the vessel in gauging how far it may be filled or in determining the current level of liquid within the vessel.

The primary casing 100 is made of a material appropriate for the storage of beverages and more particularly beer, such as a food-grade plastic, aluminum, stainless steel, and any other suitable material that is known in the art. Some materials have an affinity for esters present in beer, and thus are not desirable for this purpose. Furthermore, some materials are more permeable to oxygen, carbon dioxide, and other gases than others. The primary casing material preferably does not have an affinity for esters present in beer and also has a low oxygen permeation rate. The material is preferably one that is rigid enough to hold beverages and withstand the weight and pressure of the beverage and pressurization within, yet easily formed in the manufacturing process to the desired shape. A preferred material for the primary casing is a polymer which may be blow molded, such as high density polyethylene (“HDPE”). Preferably, the primary casing material is light limiting and translucent so that the fill level of the beverage can be ascertained, but the amount of light that the beverage within is exposed to is minimized. The material may also not be translucent but merely light limiting. The material is preferably a light-limiting colored HDPE, such as green, red, pink, amber, and other known colors. According to a most preferred embodiment, the primary casing is comprised of translucent amber HDPE. The primary casing may also be made of a compound material, such as a base material with a coating. For example, a base material with desirable physical characteristics, such as rigidity and easy injection formation, may be used in combination with an inner and/or coating material which has chemical characteristics that minimize flavor degradation of the beverage within, such as minimizing light degradation, chemical reactions, or oxygen permeation. Similarly, compound materials may be used for aesthetic purposes, such as for labeling the container.

Some embodiments of the present invention include a primary casing and a separate removable handle, rather than handle integrated into the primary casing (integrated handle embodiments are shown in the figures). Such separate handles may be rigid and snap into place at or near the top face, or be comprised of flexible straps, or other carrying means. Alternate embodiments may also include separate carrying straps which may be attached to the integrated handle, secured around the perimeter of the primary facing along approximately four walls of the primary casing, or otherwise attached or affixed to the primary casing.

The invention further comprises a spout or dispenser assembly, generally designated 400. According to an embodiment of the invention, the dispenser assembly is comprised of a dispenser head 420, a dispenser screw cap 440, and a dispensing mechanism. The dispensing mechanism itself may be comprised of multiple parts in a single assembly. The dispensing mechanism can include a push-button dispensing mechanism, a lever arm mechanism, a screw mechanism, or any other mechanism or valve known in the art for regulating the flow of liquids on demand through the dispenser head 420. A dispensing mechanism, on its most basic level, may include a hose attached to the dispenser head, flow through which is regulated by a clamp.

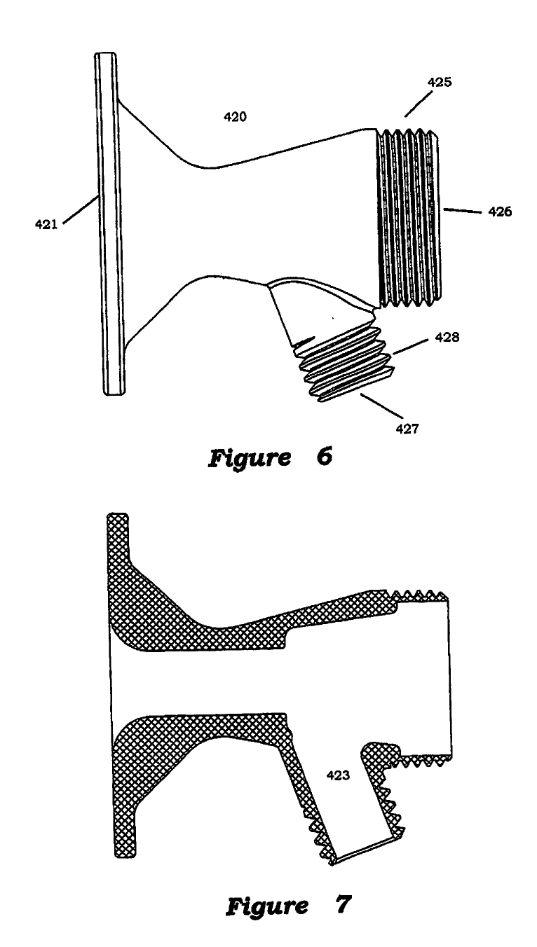

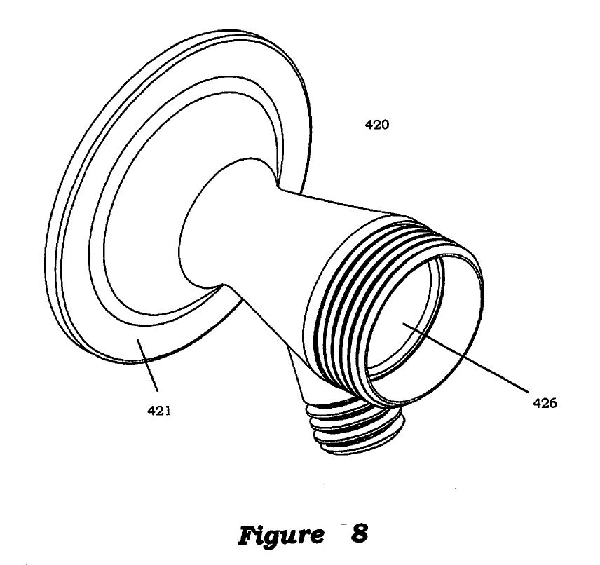

A dispenser head according to an embodiment of the invention is shown in FIGS. 6-8. The dispenser head 420 in this embodiment is comprised of a unitary injection molded piece made of a material that is also compatible with the beverage within, such as food-grade styrene or nylon. As shown in FIG. 6, the dispenser head is comprised of an approximately circular inlet edge 421. The inlet edge 421 should have an outer diameter that is approximately equal to or slightly larger than the diameter of the dispenser hole 430. The dispenser head may be attached to the dispenser hole by placing the inlet edge 421 of the dispenser head 420 against the outer edge of the circular attachment protrusion 410, then screwing the dispenser screw cap 440 onto the dispenser attachment protrusion 410. Alternately, according to an embodiment of the invention, a gasket 600 is placed between the inlet edge 421 and the circular attachment protrusion 410, then the dispenser screw cap 440 is screwed on to secure the pieces. Preferably, the gasket is made from dye cut plastic foam, and the outer diameter of the gasket is approximately the same size as the interior diameter of the dispenser screw cap 440. As shown in FIG. 7, the dispenser head includes an interior central channel 423 for the beverage to flow through when dispensed.

The dispenser head further includes a dispensing outlet 427 from which the beverage exits the container when dispensed into a cup or other drinking vessel or container. According to an embodiment of the invention as shown in FIG. 6-7, the dispensing outlet is approximately cylindrical with a threaded outer surface 428. An optional hose adapter may be attached to the dispenser head by threading a part of the cooling system with threaded outer surface 428. Alternately, the beverage may be dispensed directly from the outlet 427.

The dispenser head also includes a dispenser mechanism opening 426. The outer edge of the dispenser mechanism opening may include an outer threaded edge 425, as shown in FIG. 6, for attaching a cap to hold the dispensing engagement mechanism onto the dispenser head 420.

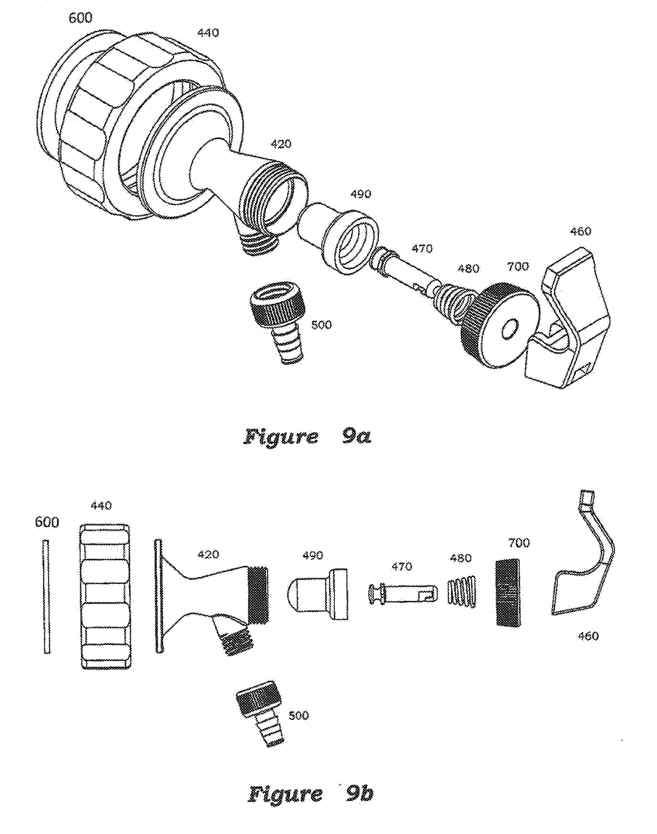

One type of dispensing mechanism that may be used according to an embodiment of the invention is a valve/spring dispensing mechanism assembly, an example of which is shown in FIGS. 9A, 9B, and 11. The dispensing mechanism embodiment shown in FIGS. 9A and 9B is comprised of a silicon rubber valve stop 490, a valve spring 480, a valve pin 470, a lever arm 460, and a retainer threaded end cap 700.

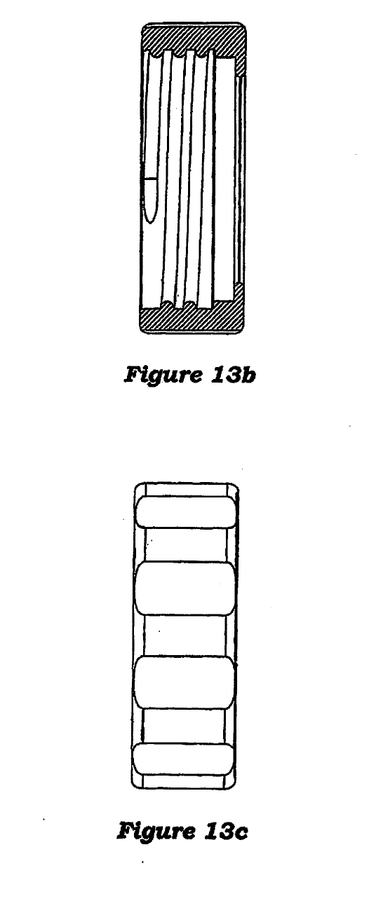

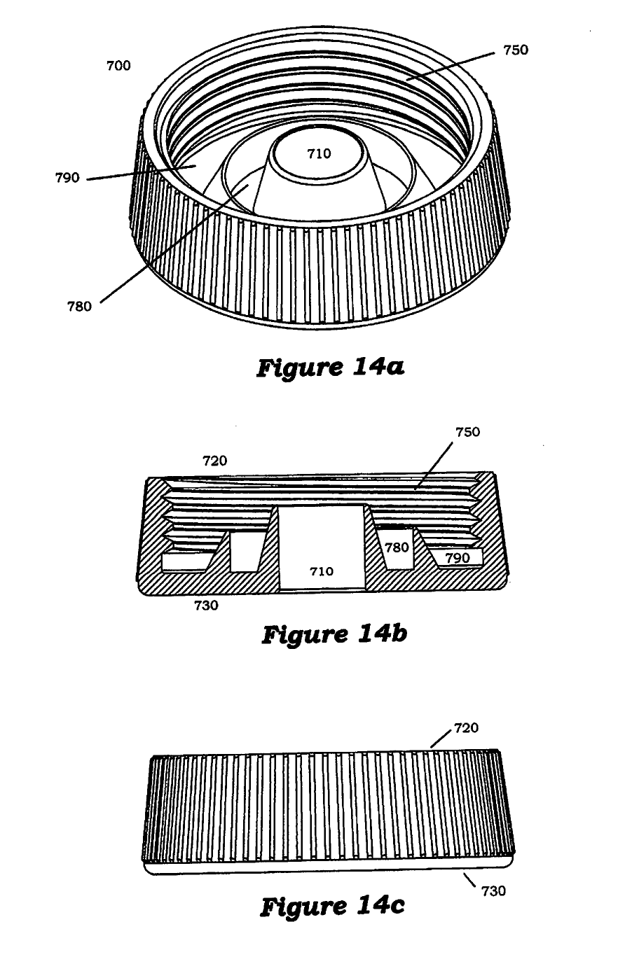

A more detailed representation of the valve and spring retainer threaded end cap according to an embodiment of the invention is provided in FIGS. 14A-14E. As shown in these figures, the valve and spring retainer threaded end cap is circular, with its stopper side 720 slightly smaller in diameter than its lever side 730. It includes threads 750 on its stopper side interior annular surface, such that it may be attached to the dispenser head 420 by screwing it onto the outer threaded edge 425 of the dispenser head. The valve and spring retainer threaded end cap also includes a center hole 710 and several annular protrusions defining resulting annular depressions, including an outer stopper seat annular depression 790 and an inner spring seat annular depression 780. The valve and spring retainer threaded end cap also optionally includes outer surface ridges 770 on its annular exterior, so that this annular exterior surface may be more easily gripped when screwing or unscrewing this component.

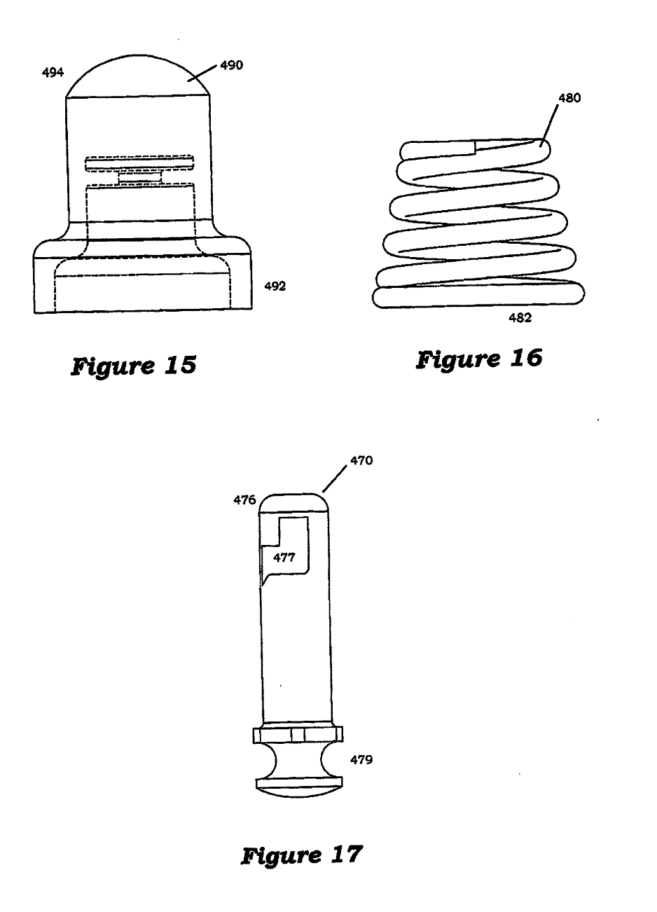

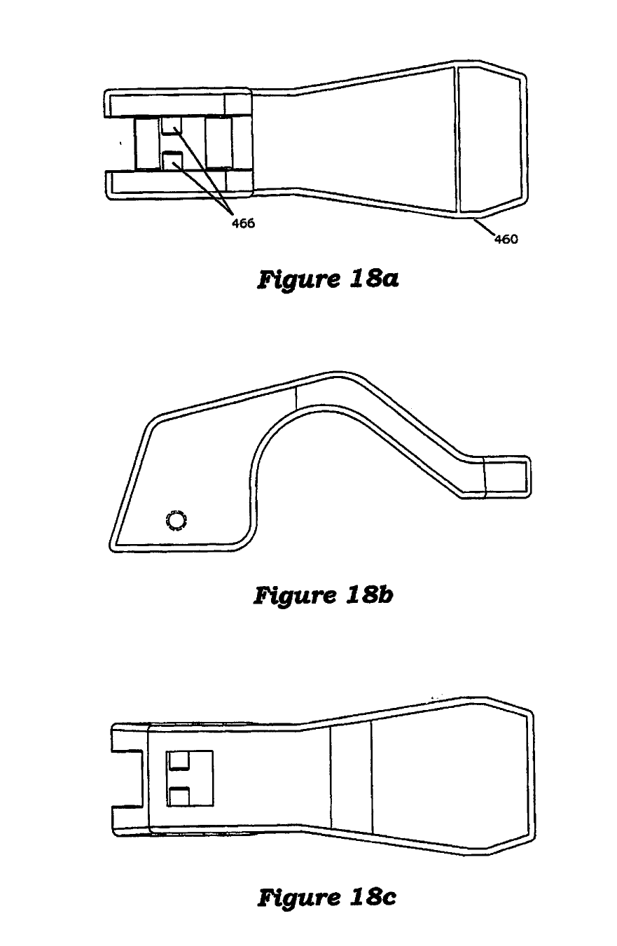

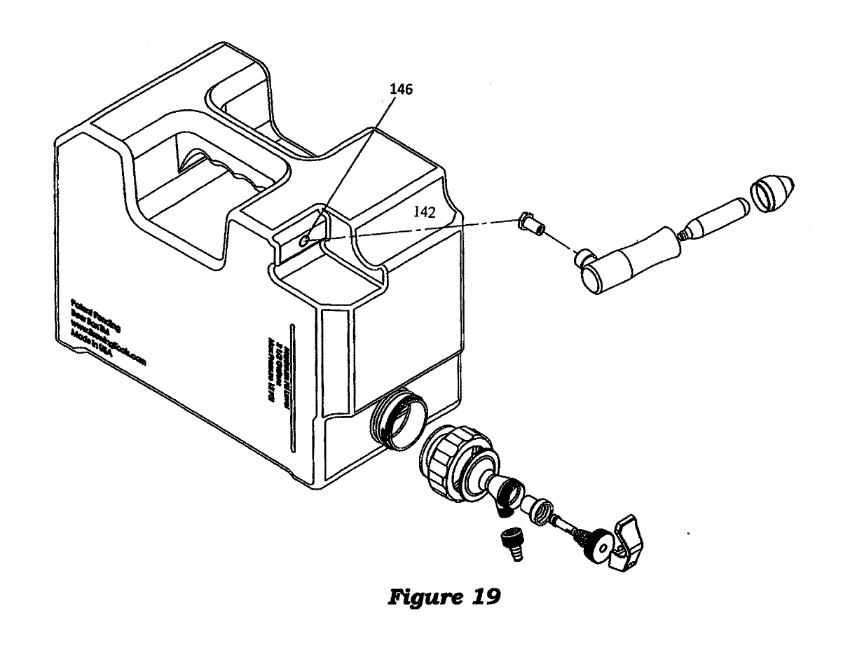

In assembling the storage vessel according to this embodiment, the dispenser head 420 may be attached to the primary casing first, as previously described herein, before the dispensing mechanism is attached, or the dispenser head with the dispensing mechanism already attached may be screwed into the primary casing. As shown in FIGS. 9A and 9B, to assemble the valve/spring dispensing mechanism according to this embodiment, the handle end 482 (as designated in FIG. 16) of the spring is inserted into the inner spring seat annular depression 780 of the retainer threaded end cap 700. The various parts of the valve stop 490, the valve spring 480, and valve pin 470 according to this embodiment are designated in FIGS. 15-17, respectively. The lever side 476 of the valve pin 470 is inserted through the center of the spring and the center hole 710 of the retainer threaded end cap. The various parts of the valve lever 460 are designated in FIGS. 18A-18C. The valve lever 460 is attached to the valve pin by inserting the lever arm pin attachment protrusions 466 into the pin's L-shaped attachment hole 477 until it locks into place. Once the valve lever 460 is secured to the valve pin 470 the open end 492 of the valve stopper 490 is placed over the stopper end of the valve pin 479 and the spring, with the open end of the stopper resting in the outer stopper seat annular depression 790 of the retainer threaded end cap. The closed end 494 of the valve stopper is then inserted into the dispenser mechanism opening 426 of the dispenser head. Then, the entire dispenser mechanism is secured to the dispenser head 420 by screwing the threads 750 on the stopper side of the valve and spring retainer end cap onto the outer threads 425 of the dispenser cap.

The valve stop or stopper 490 serves to both seal the opening in the dispenser head when the stopper is engaged, and move to allow liquid to flow out of the dispensing outlet 427 when the stopper is disengaged. The stopper may be made of any suitable material that is appropriate for food use, can easily slide along the walls of the dispenser head, and can withstand liquid pressure and conform to the interior surface of the inner walls of the dispenser head. In preferred embodiments, the valve stop 490 is made of silicone rubber. The valve spring 480 may be made of any suitable material for springs, preferably brass or stainless steel, more preferably a food-grade metal material. The valve lever and valve pin may also be made of any suitable rigid material for its intended use that may be formed into the desired shape, such as food grade styrene or nylon.

After the valve/spring dispensing mechanism is assembled and the container is fully sealed (as discussed below), the beverage within the container may be dispensed by using the dispensing mechanism assembly. To use the valve/spring dispensing mechanism assembly to dispense the liquid out of the storage vessel, a user would pull on the lever 460. In the embodiment and specific handle shape shown in FIG. 9A-9B and 18A-18C, the handle of the valve lever may be pulled up, such that the beverage flows when the handle is held in the up position, or down into a continuous flow locked state. This action would move the valve pin laterally away from the casing and towards the direction of the lever, which would in turn pull the silicone stopper 450 towards the lever. The dispensing outlet would then no longer be blocked by the silicone stopper. The beverage within the vessel would then, using the force of gravity, flow out of the dispenser head through the dispensing outlet 427. To stop the flow of the beverage out of the dispensing outlet, the user would merely push the lever back into the “up” position, thus moving the silicone stopper back to its original position blocking the dispensing outlet.

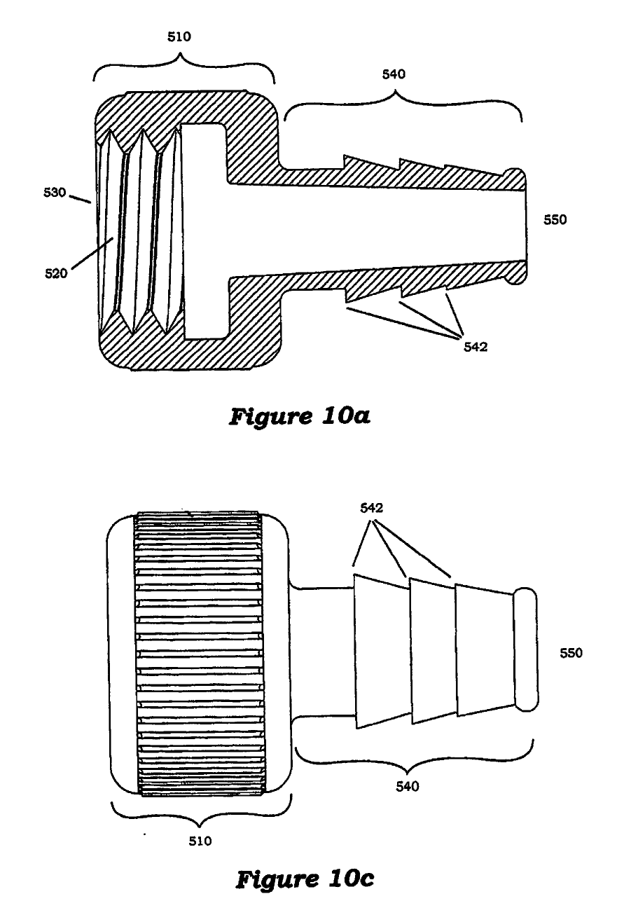

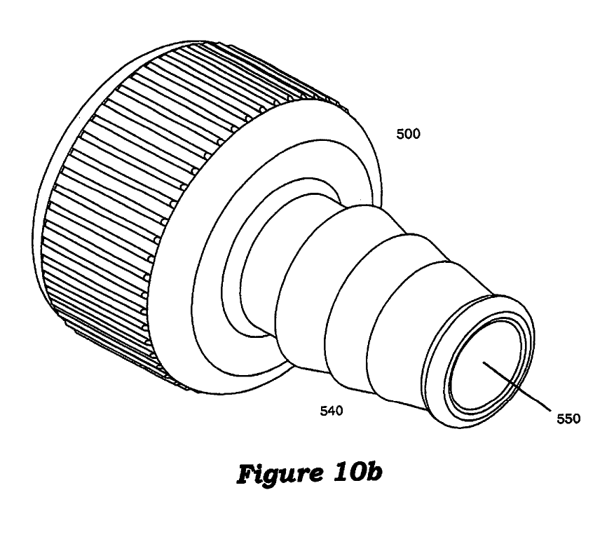

One advantage of the embodiments of the present invention is that they allow beer and other beverages to be easily transported. Thus, it is desirable to be able to place storage assemblies of the present invention in, for example, standard coolers with ice for picnics, boat trips, and other mobile adventures. Thus, it may be desirable to dispense the beverage without opening or removing it from a cooler or refrigerator, or to dispense the liquid within from a distance from the primary casing of the storage vessel. To achieve this end, embodiments of the invention may optionally include hose taps or other flow regulators, a hose, and a hose adapter. As an example of an embodiment of a hose adapter according to the invention is shown in FIGS. 10A-10D. The hose adapter 500 in this embodiment is comprised of a wider annular dispenser attachment end 510 and a narrower hose attachment end 540 with a hollow interior so that liquid may flow from one end to the other. In this embodiment, the annular dispenser attachment end has interior threads 520 so that the hose adapter may be screwed onto the threaded outer surface 428 of the dispenser outlet 427. When this is attached and the dispenser mechanism is engaged such that liquid flows, it would flow from the dispensing outlet 427 of the dispenser head 420 into the inlet end 530 of the hose adapter and out from the hose adapter at the outlet end 550 into a cup or other vessel (not shown) or into an attached hose (also not shown). A hose or other tube, preferably a food-grade silicone hose, may be attached to the hose adapter by placing the end of the hose over the one or more flanges 542 on the hose attachment end 540.

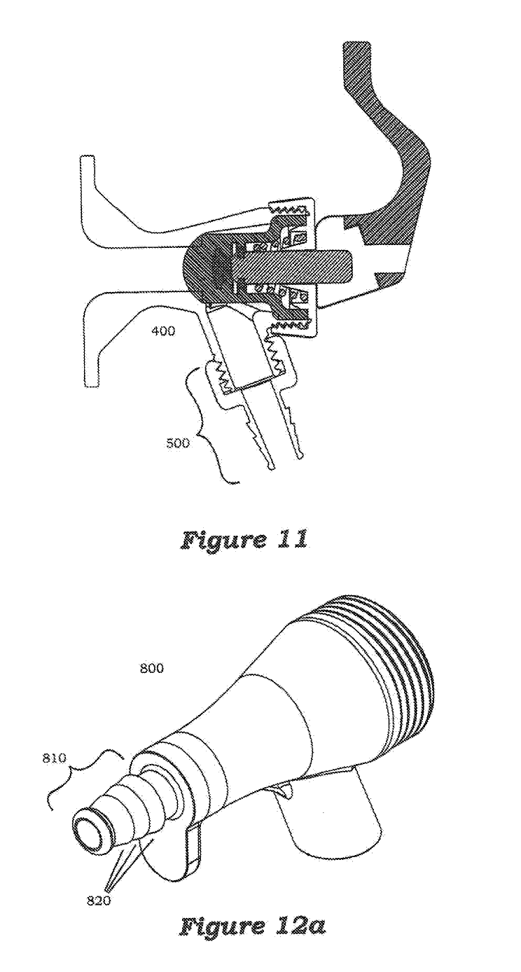

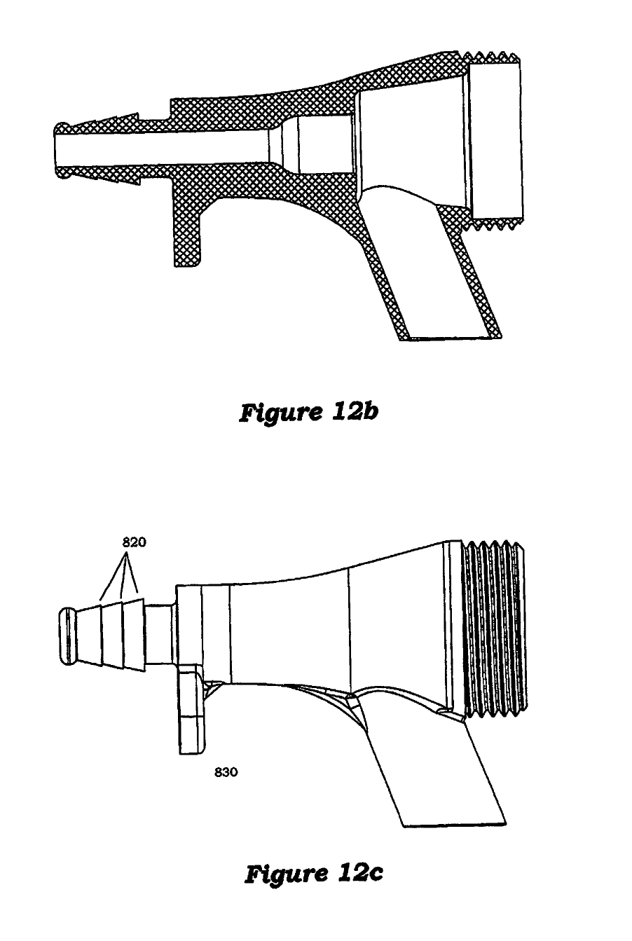

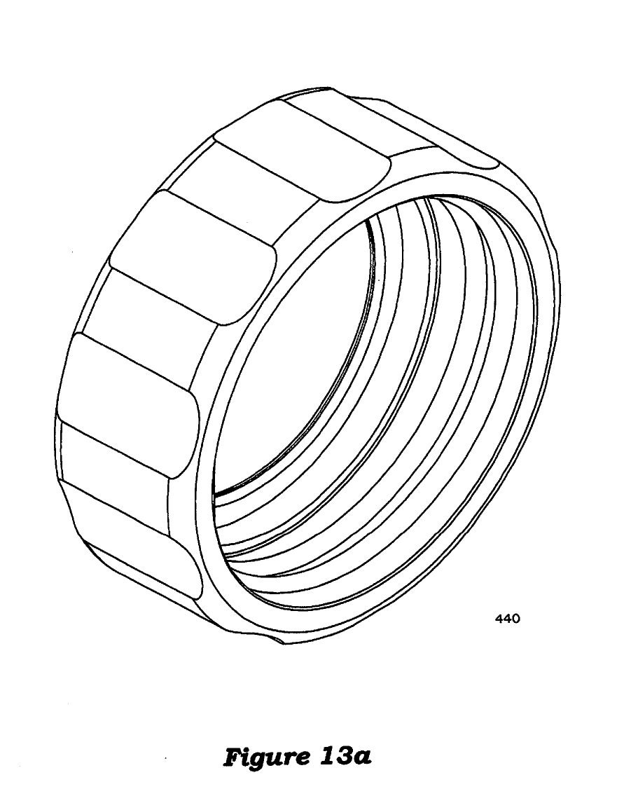

Flow of liquid through the hose may be regulated using means known in the art, including using various types of clamps on the hose or attaching another valve on the other end of the hose (i.e., the end not attached to the hose adapter 500). Picnic taps for beer kegs, usually comprising a hose and a valve mechanism are known in the art and are available through homebrew and beer suppliers. The hose attachment end 540 of the hose adapter may be sized such that standard food grade vinyl tubing as is typically used for this application in picnic tap kits may be easily attached. According to preferred embodiments, the hose attachment end is sized to fit tubing of at least 3/16 to 5/16 inches. An example of a remote valve faucet 800 that may be attached to the dispensing tubing (the end not attached to the hose adapter 500) is shown in FIGS. 12A-12C. The hose may be inserted over the inlet end 810 of the remote valve faucet as shown in FIGS. 12A-12C and held in place via the one or more protruding flanges 820. An optional finger rest 830 may protrude from the main body of the remote valve faucet 800 to allow for easier attachment and detachment of the hose.

The invention further comprises a pressurization source 200 which is used to provide pressure to the liquid within the container to maintain adequate dissolved gases and thus maintain a consistent texture and flavor of the beverage. According to preferred embodiments of the invention, a one-way valve is integrated with or attached to the upper primary case. Various means of attachment of such valves are possible, such as through an integrated threaded attachment system or by using common attachment systems. As shown in FIG. 19, in one embodiment of the present invention, the one-way valve may be attached to the top hole 146 by inserting said one-way valve into the hole and attaching it tightly to ensure a good seal that minimizes pressure loss, such as by using a nut, washer, and o-ring, as shown in FIG. 21. According to another embodiment of the invention, a right-angle elbow is attached to the top hole 146, and a one-way valve is then attached to the right angle elbow. The one-way valve may be any number of one-way valves known in the art, preferably a one-way valve with an integrated stem such as a Schrader or American valve, a Presta or French valve, a Dunlop (or Woods or English) valve, and a Regina valve. A particularly preferred valve is a stainless steel Schrader valve. The one way valve may be attached to the top hole 146 of the primary casing using, for example, and O-ring gasket and nut. A pressurization source, such as a carbon dioxide cartridge, a nitrogen cartridge, carbon dioxide regulated from a cylinder, tank or other repository source, and regulated nitrogen, may be attached to the one-way valve to introduce gas to the closed container to maintain a constant pressure. Pressurization sources of up to 45 g of carbon dioxide or nitrogen are known to be compatible with embodiments of the present invention. In preferred embodiments, the pressurization source is a 8 g to 16 g cartridge assembly comprising a ball or pin lock cartridge injector, commonly known in the art, and a 8 g to 16 g carbon dioxide cartridge (rated for human consumption), which is also known in the art. Such injectors and carbon dioxide cartridges are commonly available from kitchen/restaurant suppliers and beverage brewing supply sources, such as Williams Brewing. The gases should be delivered in a manner that does not introduce oils or other contaminants, and cartridges and cartridges designed specifically for use with food and beverage products are well-known. In a more preferred embodiment, the pressurization source is a 12 g carbon dioxide cartridge, rated for human consumption, with a ball lock cartridge injector. It is advantageous to many home brewers to use carbon dioxide cartridges, as it makes it easier for the brewer to brew and store batches if the materials are readily available. As indicated previously, an embodiment of the invention as shown in FIG. 3, includes an upper seating panel 142 for placement of a pressurizing cartridge or gas tube. The upper indented region comprising an upper seating panel 142 may be curved, as shown in FIGS. 2-3 such that the pressurizing cartridge may be placed within and secured to the container.

An advantage that embodiments of the invention have over other beverage containers known in the art is an ability to withstand internal pressures above atmospheric pressure. According to an embodiment of the invention, the assembled container, including the secured dispensing element and the pressurization valve, can withstand internal pressures of more than 15 psi, more preferably more than 25 psi, most preferably more than 35 psi. It is understood by those skilled in the art that the beverage would not occupy all available space within the interior of the container, as adequate head space is needed to contain the gas within the vessel. It is understood that exact dimensions of the various elements of the embodiments of the invention may vary.

One example embodiment of the invention designed to contain approximately 2.5 gallons of beer has the following dimensions and specifications:

### EXAMPLE 1

### 2.5 Gallon Beer Vessel for a Standard Refrigerator

Primary casing material: Amber HDPE
HDPE material weight: 1.52 lb HDPE, as assembled
Approximate wall thickness: 0.09 inches
Assembled length: 15.901 inches, with dispensing spout mounted
Primary casing length: 12.228 inches
Vessel width: 6.500 inches
Vessel height: 9.000 inches
Maximum total volume: 2.826 gallons (654.47 cubic inches) Recommended liquid volume: 2.5 gallons (577 cubic inches)
Recommended head space: 1.800 inches
Approximate weight of vessel with beer in it: 21.5 lb

Preferred embodiments of the invention, including but not limited to the example provided above, are designed so that the filled vessel may be easily transported from one location to another by picking the vessel up by the handle 50. In addition to storing beer, root beer, cider, and other beverages that have been home-brewed, the assembled vessel may be used for storage and transportation of beverages such as from a bar or microbrewery to home, similar to a growler. As such, the internal volume of the vessel includes various sizes, including but not limited to 1 quart, ½ gallon, 1 gallon, 2 gallon, 2.5 gallon, 3 gallon, and 4 gallon, and 5 gallon sizes. Embodiments of the invention provide an advantage over those known in the art in that they are reusable, durable and not easily subject to breakage, and can be easily lifted with a single hand or, in some cases, a few fingers. Carbon dioxide and other inert gases can also be added at any time and periodically throughout storage of the beverage to prevent deteriorating taste and maintain adequate levels of dissolved gases in the beverage contained therein.

The invention also includes a method of filling the container. When filling the container according to this embodiment, the dispenser 400 is removed from the vessel, thus exposing the dispensing hole 430. This method includes checking the pressurization valve to ensure it is secure, turning the vessel so that it rests on the back face 150 or that the back face 150 is generally facing down, filling the vessel with liquid through the dispensing hole 430, attaching the dispenser 400 to create a secure seal. The vessel may then be righted such that the bottom face 110 is facing downward. The method may optionally include pressurizing the vessel with the pressurization source 200 any time after the dispenser is attached to create a secure seal.

The invention further includes a method of cleaning the container. The container assembly may be disassembled and cleaned using soap and water, bleach, and any commercially available cleaners and sanitizers, such as Five Star and Star San HB. When cleaning and/or filling the container according to this embodiment, the dispenser 400 is removed from the vessel, thus exposing the dispensing hole 430. As previously indicated, and fill tubes brushes may be easily inserted into the dispensing hole 430, which allows for easier cleaning. Similarly, the integrated feet 12 and 13, may be easily reached with brushes and pressurized water so the contaminants may be removed and the entire vessel easily sanitized. Removable parts may all be soaked and individually cleaned as needed. The design of the primary casing, in particular, allows for easier cleaning than other types of containers known in the art, many of which have small openings, crevices, and grooves which are hard to clean.

It should be emphasized that the above-described embodiments of the present disclosure are merely possible examples of implementations, merely set forth for a clear understanding of the principles of the disclosed systems and methods. Many variations and modifications may be made to the above-described embodiment(s) without departing substantially from the disclosed principles of the systems and methods. All such modifications and variations are intended to be included herein within the scope of this disclosure and the present disclosure and protected by the following claims.

That which is claimed:

1. A reusable vessel for storing beverages with dissolved gases comprising:
(a) a rectilinear primary casing made from food-grade polymer comprising front face, a bottom face, a back face, two side faces, and a top face, wherein the top face includes an integrated top handle, the front face includes a dispenser hole located on its bottom half, and the front face includes a valve for pressurization located on its top half, and
(b) a removable dispensing head and dispensing mechanism,
wherein the removable dispensing head is attached to the primary casing at the dispenser hole.

2. The vessel as claimed in claim 1 further comprising a pressurization source.

3. The vessel as claimed in claim 2, wherein the pressurization source comprises a carbon dioxide or nitrogen cartridge assembly.

4. The vessel as claimed in claim 3, wherein the pressurization source comprises (a) a threaded injector and (b) a carbon dioxide or nitrogen cartridge with an initial capacity of 8 grams to 16 grams.

5. The vessel as claimed in claim 3, wherein said front face and top face are connected by an upper seating panel, and wherein said cartridge assembly rests on said upper seating panel.

6. The vessel as claimed in claim 1, wherein said removable dispensing head comprises: a horizontal main body which is tubular, a flatly flared liquid inflow end, a dispenser mechanism attachment end opposite the liquid inflow end of the main body, and a liquid outflow conduit protruding from the horizontal main body, wherein the mechanism attachment end has exterior screw threads around its perimeter.

7. The vessel as claimed in claim 6, wherein the liquid outflow conduit has screw threads around its exterior end.

8. The vessel as claimed in claim 7 further comprising a hose adapter, said hose adapter having a hollow interior and comprising: a wider annular dispenser attachment end and a narrower hose attachment end, wherein the annular dispenser attachment end has interior screw threads, and wherein the narrower hose attachment end is shaped like a hollow cone with at least one exterior annular flanges.

9. The vessel as claimed in claim 8 further comprising a dispenser hose, wherein said dispenser hose is attached over the narrower hose attachment end and secured by the flanges.

10. The vessel as claimed in claim 1, wherein said primary casing is comprised of high density polyethylene.

11. The vessel as claimed in claim 1, wherein said primary casing is comprised of light-limiting high density polyethylene.

12. The vessel as claimed in claim 1, wherein the side faces are a first side face and a second side face, further comprising: a first corner face connecting the front face to the first side face, a second corner face connecting the front face to the second side face, a third corner face connecting the first side face to the back face, and a fourth corner face connecting the second side face to the back face.

13. The vessel as claimed in claim 1, further comprising: at least two integrated feet—a first integrated foot and a second integrated foot, molded into and thus protruding from said bottom face, wherein the first integrated foot runs along the edge of the front face, and whereas the second integrated foot runs along the edge of the back face.

14. A method of storing and dispensing carbonated beverages or fermented beverages comprising: (a) obtaining a rectilinear primary casing comprising a front face, a back face, and two side faces, said front face comprising an upper half and a lower half, with a hole in the lower half of the front face and a valve stem at the upper half of the front face, (b) filling said primary casing with liquid through said dispenser hole, (c) obtaining and attaching a dispenser mechanism, (d) obtaining and attaching a pressurization source to said one-way valve thus forming a sealed vessel, (e) adding pressurized gas to the interior of the vessel, (f) refrigerating the vessel, and (g) when desired, dispensing the liquid from the vessel using the dispenser mechanism.

15. A reusable vessel for storing beverages with dissolved gases comprising:
(a) a non-curvilinear primary casing made from food-grade polymer comprising a front face, a bottom face, a back face, two side faces, and a top face, wherein, the front face includes a dispenser hole located on its bottom half, and the front face includes a valve for pressurization located on its top half, and
(b) a removable dispensing head and dispensing mechanism,
wherein the removable dispensing head is attached to the primary casing at the dispenser hole.

16. The vessel as claimed in claim 15 further comprising a handle integrated in said top face.

17. The vessel as claimed in claim 15 further comprising a pressurization source.

18. The vessel as claimed in claim 1, wherein said rectilinear primary casing is a unitary molded casing.

19. The vessel as claimed in claim 1, wherein said rectilinear primary casing is a unitary blow-molded casing.

20. The vessel as claimed in claim 3, wherein said valve for pressurization comprises an externally threaded valve stem with an internal spring-loaded pin within said valve stem, and wherein the pressurization source comprises a carbon dioxide or nitrogen cartridge with an initial capacity of 8 grams to 16 grams.
